(19) United States
(12) Patent Application Publication
(10) Pub. No.: US 2018/0065526 A1
(43) Pub. Date: Mar. 8, 2018

(54) HEATING DEVICE FOR MOTOR VEHICLE SEAT

(71) Applicant: Faurecia Sièges d'Automobile, Nanterre (FR)

(72) Inventors: Florent LONGATTE, Rambouillet (FR); Elise BEAUREPAIRE, Cercottes (FR); Mathieu CLUET, Etampes (FR)

(21) Appl. No.: 15/693,681

(22) Filed: Sep. 1, 2017

(30) Foreign Application Priority Data
Sep. 3, 2016 (FR) 1658211

(51) Int. Cl. B60N 2/56; H05B 3/34

(52) U.S. Cl. CPC B60N 2/5685; H05B 3/34

(57) ABSTRACT

A heating device for a motor vehicle seat includes a mat having first and second resistors which can be controlled independently of one another. The first and second resistors respectively form a loop between their two terminals, the two loops thus formed being wholly or partly inscribed one inside the other.

### TECHNICAL FIELD

The present invention relates to heating devices for motor vehicle seats.

More particularly, the invention relates to a heating device for a motor vehicle seat, comprising a heating mat including an electrical resistor (“resistor” hereinafter) intended to be connected to the terminals of a power supply.

### BACKGROUND

FIG. 1 illustrates a first example of such a heating device. In this example, a resistor 12, in the form of a wire, extends in a serpentine manner on substantially the entire surface of a mat 14, forming a regular pattern of meanders, the mat 14 being intended to be received in a motor vehicle seat. Such a heating device 10 makes it possible to obtain a substantially homogeneous distribution, on the surface of the mat 14, of the thermal power delivered by the resistor 12. The resistor 12 has two terminals 16, 18 supplying electric power to the resistor 12. A temperature sensor 20 is provided here, adapted for measuring the temperature of the resistor 12 in order to regulate the temperature of the resistor 12.

FIG. 2 illustrates a second example 22 of a heating device for a motor vehicle seat. According to this second example, the mat 14 comprises a resistor 12 which extends in a serpentine manner, forming patterns of meanders which differ in the three separate sections 14a, 14b, 14c of the mat 14 successively occurring in the lengthwise direction of the mat 14. In the first longitudinal end section 14a of the mat 14, the resistor 12 is absent from the central portion and extends only near the edges of the mat 14. In the middle section 14b, immediately adjacent to the first longitudinal end section 14a, the resistor 12 forms “S”-shaped meanders which extend along substantially the entire width of the mat 14. Finally, in the second longitudinal end section 14c of the mat 14, on the opposite side of the middle section 14b than the first section 14a, the resistor 12 forms meanders extending on substantially the entire width of the mat 14 and which are less wide than in the middle section 14b. The example 22 of FIG. 2 makes it possible to obtain a non-uniform distribution of thermal power in the motor vehicle seat equipped with the mat 14, in order to provide more heat to certain parts of the body of the motor vehicle seat occupant.

### SUMMARY

An object of the invention is to improve the heating of a motor vehicle seat in order to make this heating more pleasant for the seat occupant.

This aim of the invention is achieved by means of a heating device for a motor vehicle seat, comprising a mat having first and second resistors which can be supplied power independently of each other, the first and second resistors respectively forming a loop between their two terminals, the two loops thus formed being wholly or partly inscribed one inside the other.

Thus, it is advantageously possible with the heating device according to the invention to heat different areas of the motor vehicle seat at different temperatures and/or at different times, by means of resistors which can be supplied power independently of each other. This improves the comfort of the motor vehicle seat for its occupant.

In addition, each resistor forms a loop. The term “loop” is understood here in its broadest sense, meaning a curved line that closes on itself. This makes it possible for the terminals of the first and second resistors to be positioned close to one another, in particular in proximity to the same end of the mat. The supply of power to the resistors is thus facilitated, as all the electrical contacts are located in proximity to each other.

It should be noted here that between the two terminals, the curved line formed by each resistor may follow a serpentine path, forming meanders of all possible geometries.

In addition, when the loops of the first and second resistors are integrally inscribed one inside the other, there is no overlap between resistors where one resistor crosses over the other. Such a configuration is preferred, even when the loops are only partially inscribed one within the other. This reduces the risk of hot spots and the thickness of the mat.

According to preferred embodiments, the device according to the invention has one or more of the following characteristics, alone or in combination:
one among the first and second resistors extends in a serpentine manner on only part of the mat, in particular on only a section of the mat;
the first resistor extends in a serpentine manner on a first part of the mat, possibly on the entire surface of the mat, and the second resistor extends in a serpentine manner on only a second part of the mat, in particular on only a section of the mat, the first and second parts of the mat overlapping, the second part of the mat being in particular included in the first part of the mat;
the first resistor extends in a serpentine manner on the first part of the mat, possibly on the entire surface of the mat, forming first meanders, and the second resistor extends in a serpentine manner on the second part of the mat, in particular on only a section of the mat, forming second meanders, the first and second meanders alternately being inscribed one inside the other on the portion of the mat where the first and second parts of the mat overlap, in particular on the second part of the mat when the latter is included in the first part of the mat, the first and second meanders preferably extending in parallel on the portion of the mat where the first and second parts of the mat overlap;
the first resistor extends in a serpentine manner on only a first part of the mat, in particular on only a first section of the mat, and the second resistor extends in a serpentine manner on only a second part of the mat, in particular on only a second section of the mat, the first and second parts of the mat being arranged so that they do not cover one another;
the second part of the mat is a longitudinal end section of the mat;
the second part of the mat is a middle section of the mat;
the mat extends substantially in a plane, and the first and second resistors extend substantially in the plane of the mat;
the heating device comprises a second mat, the second mat preferably having a third resistor and a fourth resistor which can be supplied power independently of one another;
the first and second resistors have different resistance values, in particular have different linear resistance values;
the heating device comprises at least one temperature sensor for measuring the temperature of one of the resistors, the device preferably comprising as many temperature sensors as there are resistors;
the first resistor and the second resistor are electrically in parallel; and
the heating device further comprises a control device suitable for separately controlling the first and second resistors.

The invention also relates to a motor vehicle seat comprising a seating part, a backrest, and a heating device for a motor vehicle seat as described above in any of its combinations, a mat of the heating device being arranged in the seating part and/or the backrest.

### BRIEF DESCRIPTION OF DRAWINGS

Other features, objects, and advantages of the invention will be apparent from the following description which relates to the accompanying drawings, in which:

FIG. 1 schematically represents a section view of a first known example of a heating device for a motor vehicle seat,

FIG. 2 is a schematic section view of a second known example of a heating device for a motor vehicle seat,

FIG. 3 illustrates a side view of a motor vehicle seat on which an occupant is seated,

FIG. 4 illustrates a longitudinal section view of a first mat of the heating device of the seat of FIG. 3, equipping the seating part of the seat,

FIG. 5 represents a longitudinal section view of a second mat of the heating device of the seat of FIG. 3, equipping the backrest of the seat,

FIG. 6 schematically represents a cross-sectional view along line VI-VI of an exploded view of the mat of FIG. 5,

FIG. 7 is a longitudinal sectional view of a variant of the first mat of the heating device of FIG. 4, and

FIGS. 8 to 10 illustrate alternate shapes of the meanders which can be formed by the resistors of the mats of FIGS. 4, 5, and 7.

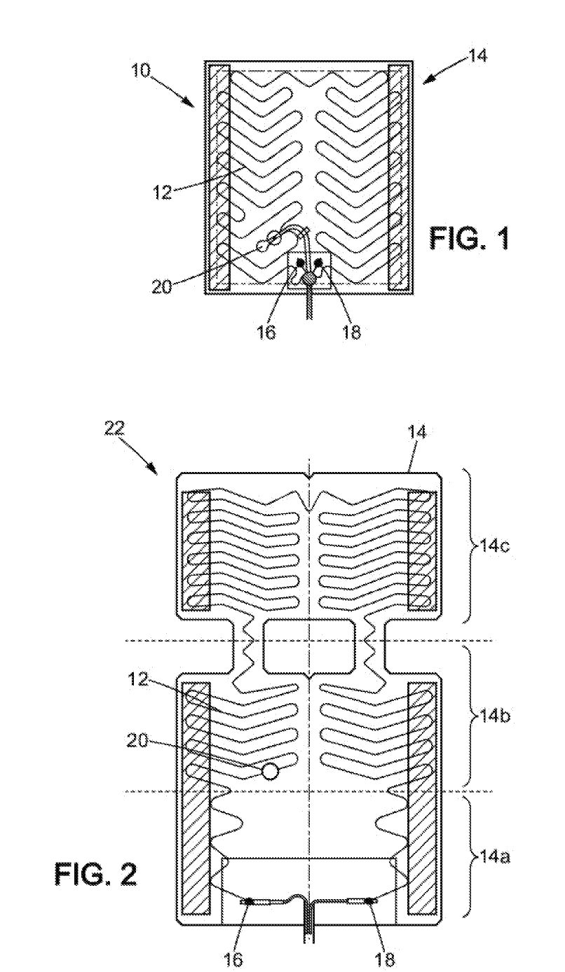

### DETAILED DESCRIPTION

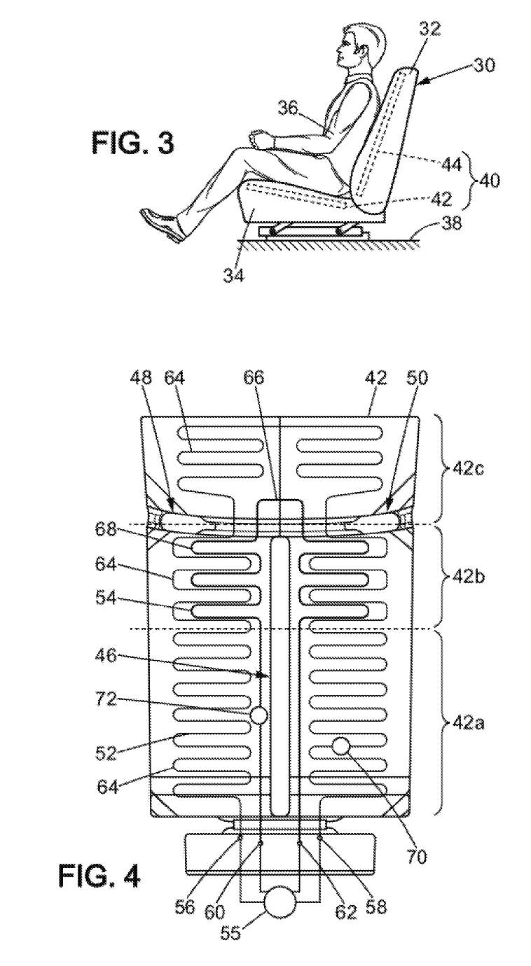

FIG. 3 illustrates a seat 30 of a motor vehicle. As represented in FIG. 3, this seat 30 comprises a backrest 32 and a seating part 34 which are provided for supporting an occupant 36. The seating part 14 is itself supported by the floor 38 of a motor vehicle.

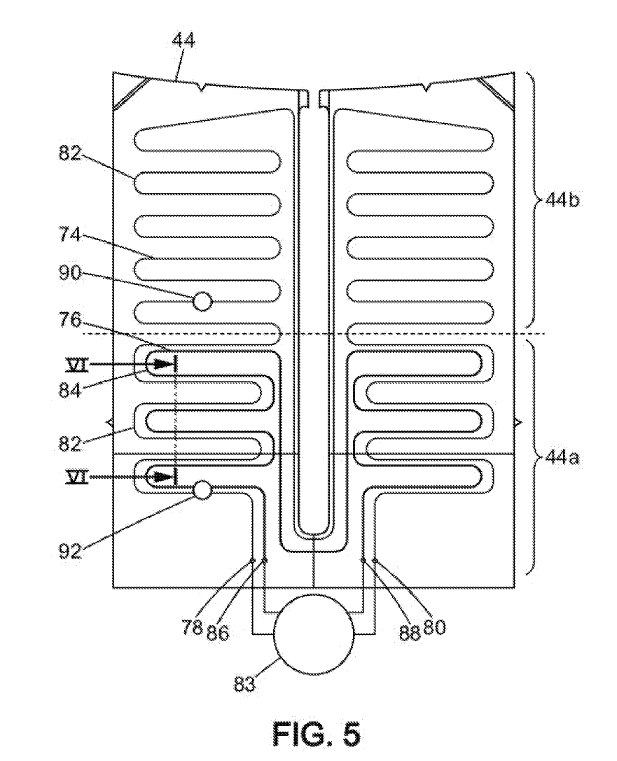

The seat 30 further comprises a heating device 40, here consisting of two mats 42, 44 respectively illustrated in FIGS. 4 and 5. More specifically, FIG. 4 illustrates a first mat 42 of the heating device 40, intended to be inserted into the seating part 34 of the motor vehicle seat 30, while FIG. 5 shows a second mat 44 of this heating device, intended to equip the backrest 32 of the motor vehicle seat 30.

“Mat” is understood to mean a substantially planar structure in which two dimensions, its length and width, are much greater than its third dimension, its thickness. In particular, the thickness of a mat may be five times smaller, preferably ten times smaller, more preferably one hundred times smaller, than the length and/or width of the mat. In practice, the mat can have dimensions of about 500×300 mm for the backrest or 400×300 mm for the seating part.

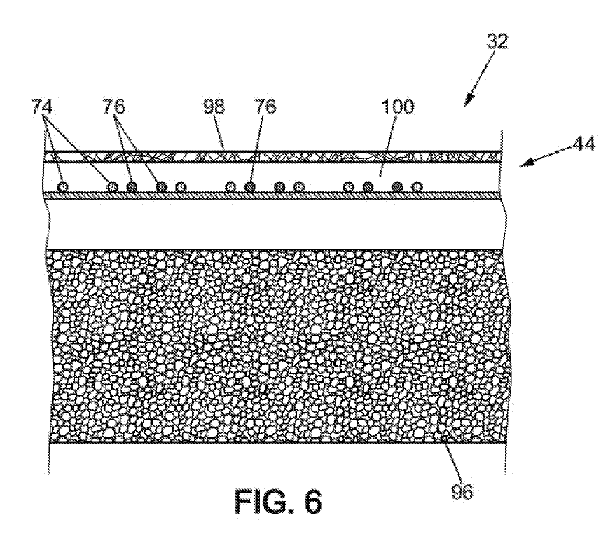

The mat 42, intended to be inserted into the seating part 34, is here of substantially trapezoidal shape, in this example with a longitudinal slot 46 in substantially two thirds of its length for the purposes of fixing the seat cover by means of an attaching line. Two openings 48, 50 are also provided, in this example, at one end of the longitudinal slot 46, these two openings making it possible to fix the cover 98 to the seat (see example of FIG. 6). The mat 42 is provided with two resistors 52, 54. The two resistors 52, 54 may be different. In particular, these two resistors 52, 54 may have different resistance and/or linear resistance values. Each resistor 52, 54 is, for example, a multi-stranded resistance wire, for example of copper, copper alloy, conductive alloy such as stainless steel, or carbon. Each resistor 52, 54 forms a loop between its respective terminals 56, 58, 60, 62, which bypasses the longitudinal slot 46 and the openings 48, 50. The respective terminals 56, 58, 60, 62 of the two resistors 52, 54 are thus arranged in proximity to the same longitudinal end of the mat 42. The loops thus formed preferably extend in the same plane, preferably a plane of extension of the mat 42, in order to limit the thickness of the mat 42. Furthermore, here the loops formed by the two resistors 52, 54 are wholly inscribed one inside the other, so that the resistors do not overlap. The two resistors 52, 54 each extend along the two lateral halves of the mat 44, separated by the longitudinal slot 46.

More precisely, as can be seen in FIG. 4, the first resistor 52 extends in a serpentine manner on substantially the entire surface of the mat 42. “Serpentine” is understood here to mean “forming S shapes”, or more generally, successive meanders 64. In order to ensure efficient heating on the entire surface of the mat 42, the meanders 64 of this first resistor 52 have an elongated and narrow shape with a more or less dense distribution in order to obtain the desired heating density. In particular, in the case of meanders 64 oriented in the widthwise direction of the mat, as represented in FIG. 4, the length of the meanders 64 measured in the widthwise direction of the mat 42 may be between 15% and 40% of the width of the mat 42. Additionally or alternatively, the width of the meanders measured in the lengthwise direction of the mat 42 may be between 3% and 20% of the length of the mat 42. In practice, the width of the meanders 64 may be greater than or equal to 10 mm. The dimensions of the meanders 64 formed by the first resistor 52 indicated herein can also apply in the case where the meanders are oriented in the lengthwise direction of the mat 42, as well as to the meanders formed by the other resistors 54 of the heating device, which will be discussed below.

However, it should be noted here that in a middle section 42b of the mat 42, the resistor 52 forms meanders 64 which are wider than in the longitudinal end sections 42a, 42c where the meanders all have substantially the same width. “Section” is understood to mean a portion of the length of the mat 42, defined in the plane in which the mat 42 extends, as opposed to its thickness.

The second resistor 54 also extends on substantially the entire surface of the mat 42, in particular in the three sections 42a, 42b, 42c defined above. However, the second resistor 54 extends in a serpentine manner only in the middle section 42b of the mat 42. In the longitudinal end sections 42a, 42c, the second resistor 54 extends in a straight line, essentially longitudinally, except for the transverse segment 66 where the resistor 54 passes from one lateral half of the mat 42 to the other. Thus, the second resistor 54 extends in a serpentine manner on only a section 42b of the mat 42, of a smaller area than the total area of the surface of the mat 42 in which the first resistor 52 extends in a serpentine manner. This second resistor 54 can be supplied power independently of the first resistor 52, by means of a control device 55 adapted to control the first and second resistors 52, 54 separately. The control device 55 may in particular comprise an electric generator common to the two resistors 52, 54, capable of delivering different levels of energy on command. The control device 55 may also comprise an electronic control unit (TCU—Thermal Control Unit) able to control the supply of power to the resistors 52, 54, which are electrically connected in parallel. The TCU may comprise predefined heating profiles, corresponding to heating parameters for each resistor 52, 54. The TCU is programmed to control the independent heating of the resistors 52, 54 according to one of the profiles, upon receipt of a command, for example from the occupant, and/or as a function of temperatures measured by means of temperature sensors 70, 72, described hereinafter. It is thus possible to control the temperature and/or timing of the heating of the middle section 42b of the mat 42, independently of the longitudinal end sections 42a, 42c.

Note here that the meanders 68 formed by the second resistor 54 extend near the meanders 64 formed by the first resistor 52. In particular, meanders 68 of the second resistor 54 are inscribed within meanders 64 of the first resistor 52 and vice versa. More specifically, the meanders 64, 68 of the first and second resistors 52, 54 are alternately inscribed one inside the other. In other words, a meander 68 of the second resistor 54 inscribed in a meander 64 of the first resistor 52 is followed, along the resistors 52, 54, by a meander 64 of the first resistor 54 inscribed in a meander 68 of the second resistor 54, and vice versa. This configuration of the meanders 64, 68 alternately inscribed one inside the other makes it possible to obtain a high density of resistance wire per unit area, which is difficult or even impossible to obtain with a single resistor. This configuration of the meanders 64, 68 can be obtained with meanders 64, 68 which extend in parallel.

Furthermore, the temperature sensors 70, 72 provided here enable measuring the temperature of the first resistor 52 and of the second resistor 54 respectively. This information makes it possible to regulate the operation of the first and second resistors 52, 54 separately, for example by operatively connecting the temperature sensors 70, 72 to the control device 55, in particular to the TCU. The temperature sensors 70, 72 are for example thermistors, in particular negative temperature coefficient thermistors or “NTC”.

As illustrated in FIG. 5, mat 44 of the heating device 40, intended to equip the backrest 32 of the seat 30, is provided with two resistors 74, 76.

In this example of FIG. 5, the mat 44 has a U shape.

A first resistor 74 extends in a serpentine manner on substantially the entire surface of the mat 44. This first resistor 74 thus enables substantially uniform heating over the entire surface of the mat 44. The first resistor 74 extends in a plane between its two terminals 78, 80, thus forming a first loop, bypassing the longitudinal opening in the mat 44 that is formed between the two arms of the U. Note here that in a first section 44a of the mat 44, the first resistor 74 forms meanders 82 that are substantially wider than in a second section 44b of the mat 44, complementary to the first section 44a, where all the meanders 82 have substantially the same width.

The second resistor 76 extends only in the first section 44a of the mat 44. Here, the second resistor 76 extends in a serpentine manner in this entire first section 44a of the mat 44. The second resistor 76 can be supplied power independently of the first resistor 74, by means of a control device 83 suitable for separately controlling the first and second resistors 74, 76. It is thus possible to control the temperature and/or the timing of the heating of section 44a of the mat 44, independently of the complementary section 44b. Control device 83 may be identical to control device 55 described above. Preferably, the heating device 40 comprises a single control device, adapted to control the supply of electrical power to various resistors of the two mats, independently of one another.

In the first section 44a, the meanders 84 formed by the second resistor 76 are in proximity to the meanders 82 formed by the first resistor 74. In particular, the meanders 84 of the second resistor 76 and the meanders 82 of the first resistor 74 are alternately inscribed one inside the other. The meanders 84 of the second resistor 76 and the meanders 82 of the first resistor 74 extend in parallel. This makes it possible to obtain a high density of resistance wire per unit area, which is difficult or even impossible to obtain with a single resistor.

Note here that the second resistor 76 extends substantially in a plane, between its two terminals 86 and 88, thus forming a second loop totally inscribed within the first loop formed by the first resistor 74. The plane in which the first resistor 74 extends is advantageously the same plane as that in which the second resistor 76 extends, in order to reduce the thickness of the mat. This plane advantageously corresponds to a plane of extension of the mat 44.

In addition, temperature sensors 90, 92 are provided here for measuring the temperature of the first resistor 74 and the second resistor 76 respectively. This makes it possible to regulate the operation of these resistors 74, 76 separately, for example by operatively connecting these temperature sensors 90, 92 to the control device 83. The temperature sensors 90, 92 are thermistors for example, in particular negative temperature coefficient thermistors or “NTC”.

The structure of mat 44 inserted into the backrest 32 of the seat 30 is illustrated by way of example in FIG. 6, it being understood that the structure of mat 42 may be identical and that mat 42 can be inserted into the seating part 34 in an analogous manner.

The backrest 32 and the seating part 34 comprise padding 96 and a cover 98 of materials of the type generally used in motor vehicle seats. The mat 44 is inserted between this padding 96 and this cover 98.

As illustrated, the mat 44 comprises a layer 100 of woven or non-woven material, for example polyester PES, onto which the first and second resistors 74, 76 are sewn. As indicated above, these first and second resistors 74, 76 preferably extend in the same plane, as illustrated, in order to reduce the thickness of the heating device 40.

The heating device as described above provides better control of its heating temperature, this temperature possibly being different in the different parts of the mat. Furthermore, by controlling the heating or non-heating of the second resistor, it is possible to control a variation in the heating time of the mat. In particular, it may be advantageous to use the second resistor 54, 76 as a booster, in particular when the heating device is turned on, in order to reach a temperature setting more quickly in certain parts of the seat provided with the heating device, and then, where appropriate, to cut off power to the second resistor 54, 76 for the normal mode of operation of the heating device.

The present invention is not limited to the one embodiment that has just been described; on the contrary, it is suitable for numerous variants accessible to a person skilled in the art.

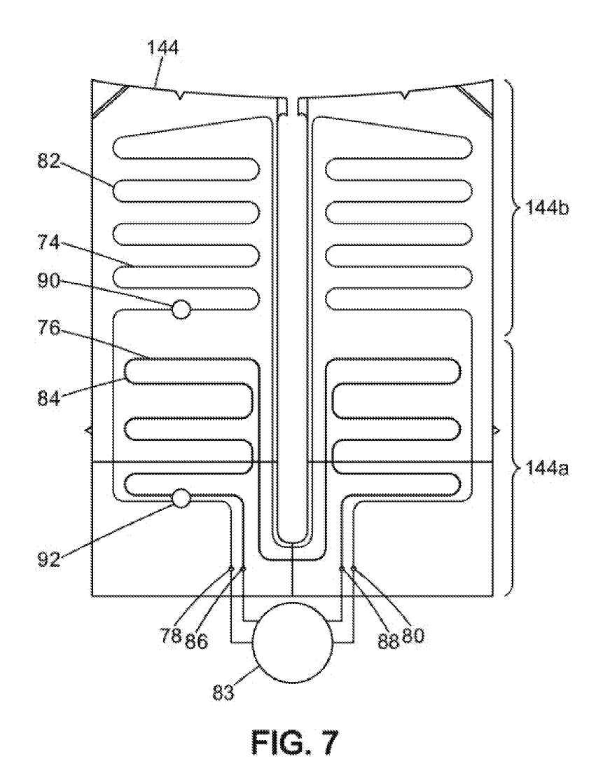

Firstly, in the examples illustrated, the second resistor extends in a serpentine manner in a part of the mat where the first resistor also extends in a serpentine manner. However, as illustrated by the variant of FIG. 7, the first 74 and second 76 resistors can extend in a serpentine manner in different parts 144a, 144b of the mat 144 which do not overlap. These parts 144a, 114b of the mat, in this case sections, are arranged so they do not cover one another. However, one can see that in this configuration, the density of resistance wire that it is possible to obtain is lower than in the configuration of the example described with reference to FIGS. 4 and 5.

More than two resistors may be provided per layer, for example as many resistors as there are mat parts which one wishes to control independently.

In the examples described, the parts in which the first and second resistors extend in a serpentine manner are defined by mat sections, meaning parts of the mat which are portions of the mat length but which include the entire width. The parts in which the resistors extend in a serpentine manner may, however, be of any suitable shape, in particular may correspond to areas which are portions of the length and/or width of the mats.

The part of the mat in which the second resistor extends in a serpentine manner may in particular have an area greater than 20% of the total area of the surface of the mat and/or less than 80% of the total surface area of the mat, preferably less than 50% of the surface area of the mat.

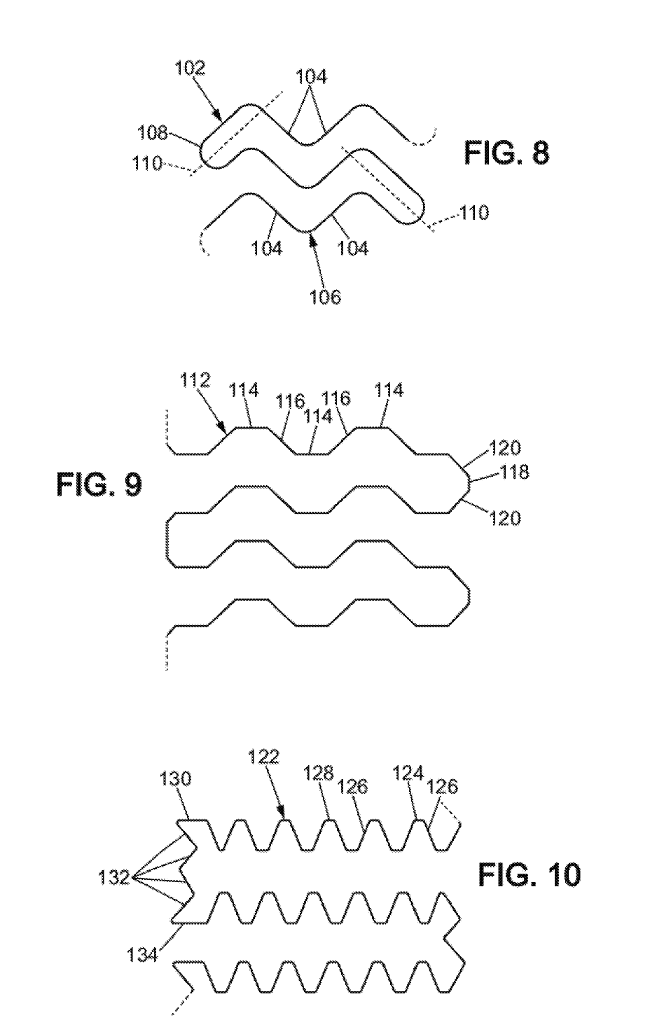

The meanders formed by the resistors illustrated in FIGS. 4, 5, and 7 are formed by transverse straight lines in the mat, connected together by circular arcs, in particular semicircles. This geometry of the meanders is not limiting, however. FIGS. 8 to 10 illustrate other possible forms of meanders, by way of examples.

In FIG. 8, for example, the meanders 102 do not form transverse straight lines in the mat, but instead straight segments 104 extending at an angle and connected by rounded corners 106. In addition, the semicircle 108 at the end of these meanders 102 has an axis of symmetry 110 oriented at an angle, substantially at the same angle as the straight segments 104.

In FIG. 9, the meanders 112 are formed by straight segments. The transverse lines of the meanders of FIGS. 4, 5, 7 are replaced by successions of transverse segments 114 extending in a transverse direction of the mat, and segments 116 at an angle. The semicircle at the end is replaced here by a succession of three straight line segments 118, 120, of which the middle segment 118 extends substantially in a longitudinal direction of the mat and the other two line segments 120 are substantially symmetrical with respect to a transverse axis of the mat.

Finally, FIG. 10 illustrates a meander 122 having successions of transverse segments 124 and segments at an angle 126, connected by rounded corners 128. The semicircle at the end of the meander is replaced here by the succession of a transverse segment 130, four segments at an angle 132, and another transverse segment 134, these segments 130, 132, 134 being connected by rounded corners as well.

Other meander geometries can be considered.

Furthermore, the number of temperature sensors used in the example is not limiting. On the contrary, a person skilled in the art knows how to adapt the number of sensors in order to achieve the desired temperature regulation(s).

In the examples described above, the loops formed by the resistors between their terminals are completely inscribed one inside the other. In other words, one entire loop is inscribed within the other. This configuration does appear to be preferred since it avoids any overlap of the resistors and provides easy access to the power supply terminals of the resistors. However, the loops may be only partially inscribed one inside the other. In this case, a loop formed by a first resistor has a portion received in the loop formed by the other resistor, and at least one portion extending outside this loop formed by the other resistor. It is then possible for the loops to overlap. However, it is preferred that the two loops do not overlap, even in this case where one loop is only partially inscribed within the other.

Finally, the control devices 55, 83 of the first and second mats may be distinct, or preferably may be merged.

1. Heating device for a motor vehicle seat, comprising a mat having first and second resistors which can be supplied power independently of each other, the first and second resistors respectively forming a loop between their two terminals, the two loops being wholly or partly inscribed one inside the other.

2. Heating device as claimed in claim 1, wherein one of the first and second resistors extends in a serpentine manner on only a part of the mat.

3. Heating device as claimed in claim 2, wherein:
the first resistor extends in a serpentine manner on a first part of the mat, and
the second resistor extends in a serpentine manner on only a second part of the mat,
the first and second parts of the mat overlapping, the second part of the mat being included in the first part of the mat.

4. Heating device as claimed in claim 3, wherein the second part of the mat is a longitudinal end section of the mat.

5. Heating device as claimed in claim 3, wherein the second part of the mat is a middle section of the mat.

6. Heating device as claimed in claim 3, wherein the first resistor extends in a serpentine manner on the first part of the mat, forming first meanders, and the second resistor extends in a serpentine manner on the second part of the mat, forming second meanders,
the first and second meanders being inscribed one inside the other on the part of the mat where the first and second parts of the mat overlap.

7. Heating device as claimed in claim 6, wherein the first and second meanders extend in parallel on the portion of the mat where the first and second parts of the mat overlap.

8. Heating device as claimed in claim 2, wherein:
the first resistor extends in a serpentine manner on only a first part of the mat, and
the second resistor extends in a serpentine manner on only a second part of the mat,
the first and second parts of the mat being arranged so that they do not cover one another.

9. Heating device as claimed in claim 8, wherein the second part of the mat is a longitudinal end section of the mat.

10. Heating device as claimed in claim 8, wherein the second part of the mat is a middle section of the mat.

11. Heating device as claimed in claim 2, wherein the first resistor extend on the entire surface of the mat

12. Heating device as claimed in claim 1, wherein the mat extends substantially in a plane and the first and second resistors extend substantially in the plane of the mat.

13. Heating device as claimed in claim 1, comprising a second mat, the second mat having a third resistor and a fourth resistor which can be supplied power independently of one another.

14. Heating device as claimed in claim 1, wherein the first and second resistors have different resistance values.

15. Heating device as claimed in claim 1, comprising at least one temperature sensor for measuring the temperature of one of the resistors.

16. Heating device as claimed in claim 1, wherein the first resistor and the second resistor are electrically in parallel.

17. Heating device as claimed in claim 1, further comprising a control device configured to separately control the first and second resistors.

18. Motor vehicle seat comprising a seating part, a backrest, and a heating device according to claim 1, the mat of the heating device being arranged in the seating part and/or the backrest.
